(19) United States
(12) Patent Application Publication
(10) Pub. No.: US 2020/0093117 A1
(43) Pub. Date: Mar. 26, 2020

(54) Flying Insect Trap

(71) Applicant: Timothy Coleton Graham, Laurel, MS (US)

(72) Inventor: Timothy Coleton Graham, Laurel, MS (US)

(21) Appl. No.: 16/580,431

(22) Filed: Sep. 24, 2019

Related U.S. Application Data
(60) Provisional application No. 62/736,134, filed on Sep. 25, 2018.

(51) Int. Cl. A01M 1/10; A01M 1/02

(52) U.S. Cl. CPC A01M 1/106; A01M 1/02

(57) ABSTRACT

The present invention provides a flying insect trap employing a scent-based insect bait to attract flying insects to the trap. Insects can enter the trap through entry pipes in the side of the trap which curve or angle downward once inside the trap. A window of clear plastic or similar material is provided in the top surface of the trap to admit sunlight and draw insects seeking to escape upward and away from the entry pipes. If the entry pipes are made of a dark, opaque material, relatively little sunlight will enter the trap through the entry pipes compared with the clear plastic window, and insects within the trap will not perceive the entry pipes as a possible exit. The trap can be constructed within a removable top cap so that the trap can be supplied with dry insect bait which can be activated before deployment by removing the cap and adding water to the dry bait.

### CROSS-REFERENCE TO RELATED APPLICATIONS

This application claims the benefit of previously filed provisional application No. 62/736,134, filed Sep. 25, 2018.

### BACKGROUND OF THE INVENTION

On farms and residential locations across the country there is no truly effective solution to the problem of flying insect control. Infestations of flying insects pose threats to residents, farm owners, and dairy farm operators, as well as most of the population that spends time outdoors. The United States Cattle industry alone suffers between $700 million and $1 billion a year in profit loss due to the damage inflicted by biting flying insects. This is due in part to the physical damage to cattle by flies (such as the horn fly) that feed on the blood of the host. Such insect pests also cause harmful levels of mental stress to cattle who cannot get away from annoying insects. The cattle industry in America alone spends approximately $60 million annually on fly control. An effective solution is needed to allow cattle farmers and cattle facilities to reallocate these funds to more productive uses.

Pesticides may reduce the problem, but pesticides require proper handling and can be hazardous to both the user and the environment. The risk of harm to animals further limits the usefulness of pesticides in controlling flying insects on farms, ranches, and other areas where livestock are present. A few insect traps that do not use pesticides are commercially available, but these traps are not effective in treating large areas, such as municipal properties or cattle farms. Such non-pesticide insect traps are generally designed for short use or single use applications. Presently there is no product that can treat large areas throughout many different regions for long periods of time without the use of pesticides. The present invention, among its many advantages, provides an answer to the horn fly epidemic and can effectively reduce the losses described above.

### BRIEF SUMMARY OF THE INVENTION

The present invention provides a new design for a flying insect trap that can be used across many different regions and for many different species of insects without using pesticide as an active ingredient. The invention is designed to prevent harm to the environment and water source. Further, it is a no-contact solution: no contact with the user in deploying the trap; no contact with the ground or water source; no contact with livestock; no contact with feed or water.

The insect trap is enclosed within a pipe or similar structure intended to be deployed in an area with a significant infestation of flying insects and, depending on the intended use or application, could be deployed anywhere from ground-level to approximately 25 feet off the ground. These traps can be constructed in a variety of sizes depending on type of installation desired. Possible Treatment Sites include but are not limited to: equine farms, bovine farms, swine farms, emu farms, ostrich farms, poultry farms, turkey farms, bovine slaughter facilities, swine slaughter facilities, equine slaughter facilities, poultry slaughter facilities, animal byproduct rendering facilities, residential housing developments, municipal parks and properties, military properties, schools.

Inside the enclosure there is a quantity of insect bait or attractant to lure insects to the trap. Different attractants may be used, depending on the species of flying insects that are being targeted. Entry pipes are located near the midway point along the length of the enclosure to allow an insect to enter the trap, while making it difficult or impossible for insects inside the trap to find their way out. To accomplish this, each entry pipe preferably includes a vertically downward turn and a gradual restriction in the diameter of the entry pipe. Through testing with various designs and variations of the insect trap disclosed herein, it has been found that the specific arrangement and dimensions of the entry pipes play an important role in the psychological manipulation of the trapped insect, both to lure it into the trap and to prevent its subsequent escape.

The upper surface of the trap enclosure includes a transparent or translucent portion, made of clear plastic or similar material. To an insect within the trap, this transparent or translucent portion of the top of the trap will appear to be an exit. The entry pipes, on the other hand, will be made of a dark opaque material. Because of the dark material and the downward turn in the entry pipes, insects inside the trap will be unable to identify them as an effective exit. Therefore, an insect inside the trap will expend its energy trying to escape through the upper surface of the trap and will die inside the trap never being able to escape. The insect dies inside the trap never being able to exit.

A typical trap according to the present invention could be approximately 6 inches in diameter and approximately 30 inches long, although a wide variety of other shapes and dimensions are possible and may be desirable depending on the application. Typically, the outside of the trap will be black or another dark color. In one embodiment, the trap features a top cap which should be removed prior to deployment to allow water to be added to a dry attractant which is included inside the trap and is inactive until combined with water. Alternatively, the trap could be supplied to the end-user without attractant, allowing the user to add the desired attractant prior to deployment, or the trap could be supplied with a liquid attractant or other attractant that does not require water for activation. The top cap may be designed with a threaded underside to allow it to be securely attached, and to be easily removed and replaced.

In a typical installation, the trap would hang vertically from a short lanyard that can be attached to two small hooks included in the removable top cap of the trap. In the alternative, the trap can be strapped to a pole or post around agricultural properties. The insect bait or attractant emits a scent which lures flying insects to the trap. Approximately halfway along the length of the trap will be one or more entry pipes that allow the scent of the insect bait to escape. Flying insects enter through these two pipes then make their way into the body of the trap. Once inside, the pipe makes a downward turn to direct the insects toward the bait, and to confuse insects inside the trap who attempt to escape.

Once inside the trap, the insects become disoriented and immediately try to escape. In a confined space, flying insects will generally seek an escape route by flying toward the most prominent apparent source of sunlight. However, because of the downward turn of the entry pipes, insects inside the trap do not perceive sunlight entering through the pipes, and do not recognize the entry pipes as possible exits. To further the confusion of insects attempting to escape, a round piece of clear plastic or other transparent or translucent material is provided in the top cap of the trap that the insect will perceive as an exit. Because of the dark color of the trap, and because sunlight is prevented from reaching the interior of the trap through the entry pipes, insects will perceive this plastic-covered opening as the only escape from the trap. The insects will continue trying unsuccessfully to escape through the top of the trap until they perish and collect in the bottom of the trap. Once full of dead flying insects the trap can be discarded, and a new trap can be deployed.

An additional benefit provided by the present invention is its ability to selectively target insects, facilitating the protection of endangered insect species. For example, several species of bee have been placed on the U.S. endangered species list in recent years, and concerns are growing about threats facing the honey bee. These concerns have led to actual and proposed legislative and regulatory action on the state and federal level, as well as internationally. The insect trap disclosed herein can be fitted with a specialized entry cap, described in more detail below, which limits access to the entry pipes to insects below a certain size. By selecting appropriate entry caps, threatened or endangered insect species can be prevented from becoming trapped. In addition, such entry caps can be used to selectively trap common predators of threatened or endangered insect species.

### BRIEF DESCRIPTION OF THE DRAWINGS

FIG. 1 is an exterior side view of the flying insect trap.

FIG. 2 is an exterior side view of the flying insect trap from a different perspective.

FIG. 3 is a side sectional view of the flying insect trap.

FIG. 4 is an exterior overhead view of the flying insect trap.

FIG. 5 is a cross-sectional view of the flying insect trap.

FIG. 6 is an exterior side view of the flying insect trap with entry caps.

FIG. 7 is a detail view of an entry cap.

FIG. 8 is an exploded exterior side view of the flying insect trap.

### DETAILED DESCRIPTION

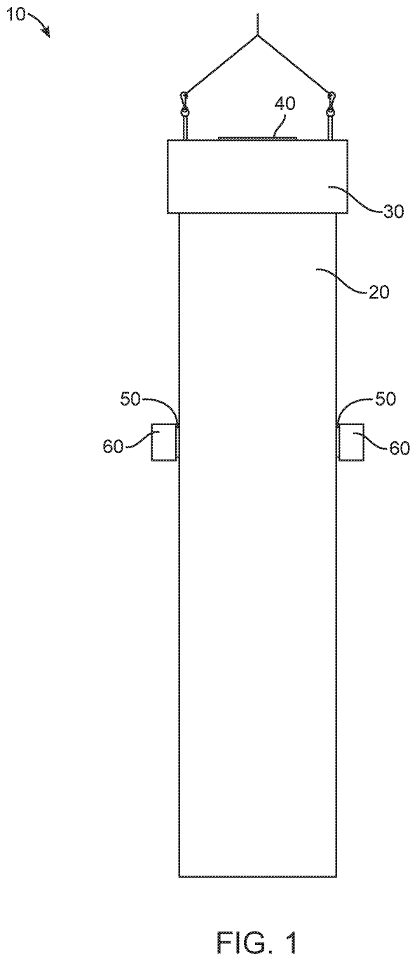

As illustrated in the accompanying figures, the insect trap (10) of the present invention features an enclosure (20), which will typically be constructed in a generally cylindrical shape, although other shapes are certainly possible and may be desirable for certain applications. In the embodiment shown in FIGS. 1 to 3, the enclosure (20) has an open top surface which is covered and sealed by a top cap (30), which is designed to be removable from the enclosure (20). Although not directly visible in FIGS. 1 to 3, the top cap (30) may include a window (40) which is transparent or translucent.

The side walls of the enclosure (20) have one or more apertures (50), with an entry pipe (60) inserted through each aperture (50). While the overall dimensions and proportions of these features may vary depending on the application to which the invention is put, a common arrangement, as shown in FIGS. 1 to 3, will have the apertures (50) and entry pipes (60) located at a position which is near the mid-point along the length of the side walls of the enclosure (20).

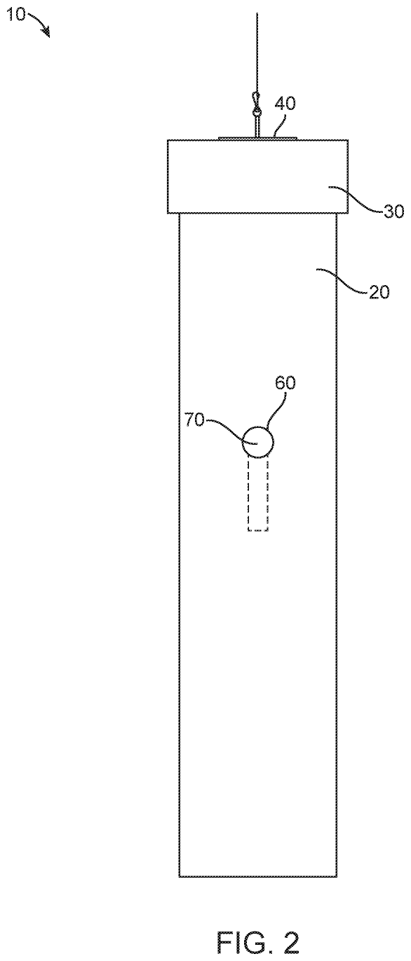

As seen in FIG. 2, each entry pipe (60) will have an outer opening (70) of a size to allow an insect of the kind targeted by the insect trap (10) to enter the entry pipe (60). The apertures (50), entry pipes (60), and outer openings (70) would typically be constructed with a generally circular cross-section, as shown in FIG. 2, primarily for ease of manufacture. The functions and advantages of the present invention do not necessarily depend on the circular or cylindrical shape of these elements, however, and those skilled in the art will recognize that other shapes could be used where desired.

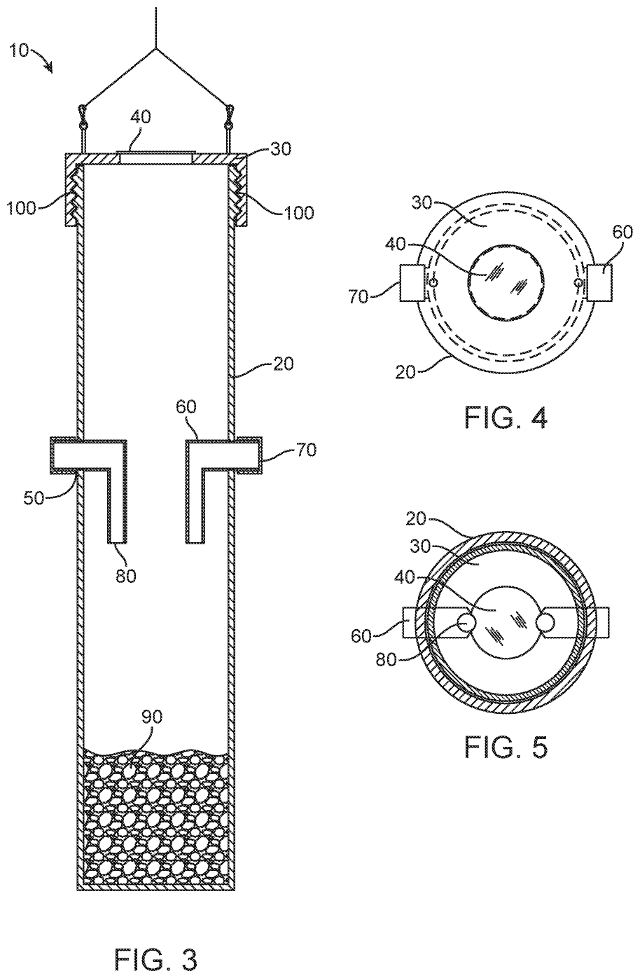

As seen in FIG. 3, each entry pipe (60) will have an inner opening (80) located within the enclosure (20). The overall shape and dimensions of the entry pipes (60) are designed to discourage insects that have reached the interior of the enclosure (20) from exiting the insect trap (10) through the entry pipes (60). Thus, for example, the entry pipes (60) can have an L-shape, as shown in FIG. 3, or otherwise be curved so that the inner openings (80) of the entry pipes (60) generally face downwards toward the bottom of the enclosure (20). In addition, the entry pipes (60) can be constructed from an opaque, preferably dark, material, or may be covered in such a material, so that insects within the enclosure (20) will not perceive sunlight entering the enclosure (20) through the entry pipes (60). It can also be desirable to make the inner openings (80) somewhat smaller than the outer openings (70) so that an insect within the enclosure (20) will find it more difficult to re-enter an entry pipe (60).

To attract insects to the insect trap (10), insect bait (90) is included within the enclosure (20). Many compositions of insect bait (90) are known and available which will emit a scent which attracts various kinds of flying insects. If the entry pipes (60) are constructed and arranged so that their inner openings (80) face downward, as described above, the attractive scent emitted from the insect bait (90) will rise, enter the entry pipes (90) through the inner openings (80), and exit the entry pipes (60), and the insect trap (10), through the outer openings (70). The scent emitted by the insect bait (90) will thus draw flying insects to the insect trap (10) and the outer openings (70) and lead them to move through the entry pipes (60) to the interior of the enclosure (20) where the insect bait (90) is located.

Certain compositions of insect bait (90) are generally inactive when dry, but only become active and begin to emit an attractive scent once water is added to the insect bait (90). An insect trap (10) containing such insect bait (90) which is dry will generally have a longer shelf-life when not in use. Thus, in one embodiment the insect trap (10) features a top cap (30) which is removable. The insect trap (10) can be stored with dry insect bait (90). When the user is ready to deploy the insect trap (10), he or she can remove the top cap (30), add water to the insect bait (90), replace the top cap (30), and place the insect trap (10) as desired. In the alternative, the insect trap (10) can be stored without insect bait (90). When the user is ready to deploy the insect trap (10), he or she can remove the top cap (30), add the desired insect bait (90), replace the top cap (30), and place the insect trap (10) as desired.

It is also desirable, although not necessarily required, that the insect bait (90) include a component with surfactant properties. Insects trapped inside the insect trap (10) may lay eggs directly in the insect bait (90) or which will fall onto the insect bait (90). If the surface tension of the water in which the insect bait (90) rests is reduced by a surfactant, insect eggs laid in or on such water will tend to become submerged, rather than remaining on the surface, and insect larvae will be unable to hatch.

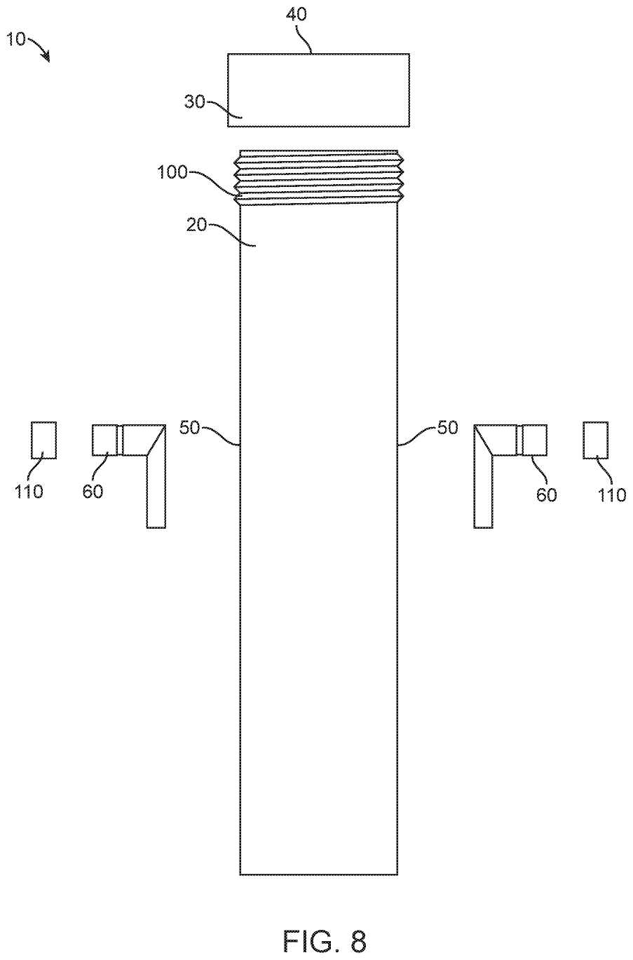

As illustrated in FIG. 3 and FIG. 8, the enclosure (20) can include threads (100) near its top, while the removable cap (30) can include matching threads (100) to allow the removable cap (30) to be attached and detached from the enclosure (20) using a simple screw-on/screw-off motion. While these drawings show the removable cap (30) fitting over the top portion of the enclosure (20), the insect trap (10) could be constructed so that a portion of the removable cap (30) fits within the enclosure (20) instead. In addition, while a threaded screw-like attachment mechanism is shown here, many other mechanisms, including but not limited to latches, bolts, or spring-loaded release buttons could be used instead to allow the removable cap (30) to be securely but detachably installed on the enclosure (20).

As described above, the removable cap (30) can include a window (40) made of a transparent or translucent material, such as clear plastic. The inclusion of such a window (40), will allow sunlight to enter the enclosure (20) from above. When trapped, most flying insects will seek an escape route primarily by flying toward the most prominent source of sunlight they can perceive. By allowing sunlight to enter the enclosure (20) from above, the window (40) helps to direct flying insects away from the entry pipes (60) in their attempts to escape. The window (40) can be seen in FIG. 4, in which the insect trap (10) is viewed from above, and in FIG. 5, in which the window (40) is seen from the inside of the enclosure (20) much as it would be viewed by an insect caught within the insect trap (10). While a transparent or translucent window (40) is likely to be the simplest and most effective means of allowing sunlight to enter the enclosure (20) without allowing trapped insects to escape, those of skill in the art will recognize other elements, such as a wire mesh or perforated metal covering, that could be substituted for the window (40) to achieve the same ends.

In some applications, it may be necessary or desirable to allow a user to add water to dry insect bait (90) or to add insect bait (90) to an empty insect trap (10). Accordingly, in an alternative embodiment of the insect trap (10), the removable cap (30) could be omitted and the enclosure (20) could be constructed with a solid, closed top surface. In this embodiment, the window (40) or other similar element could be included directly in the top surface of the enclosure (20).

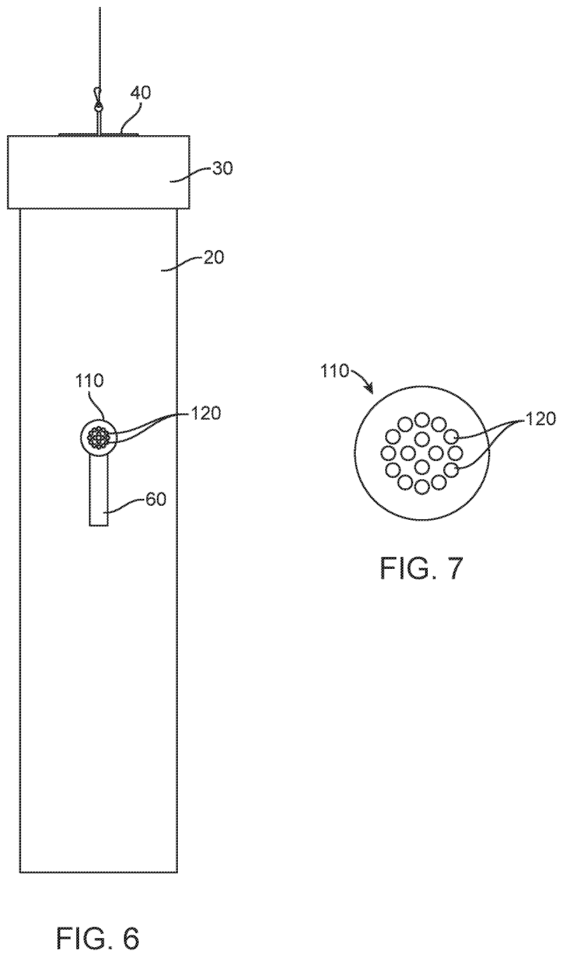

In some applications, it may be necessary or desirable to prevent certain kinds of flying insects from becoming caught in the insect trap (10). Various bee species, for instance, are protected under state and/or federal laws and regulations domestically, as well as the laws of certain foreign countries. In any application where certain kinds of insects are intended to be protected, and the protected insects are somewhat larger than the insects intended to be trapped, an entry cap (110) can be attached to cover the outer opening (70) of the entry pipe (60), as shown in FIG. 6. The entry cap (110) for such an application, detailed in FIG. 7, could be designed with a perforated surface including one or more holes (120) whose dimensions are large enough to allow the targeted insects to enter the entry pipe (60) while being too small to permit the protected insects to enter the entry pipe (60). In the alternative, the entry cap (110) could be omitted, and the entry pipe (60) could be constructed such that its outer opening (70) consists of one or more such holes (120).

The foregoing disclosure relates to, and is necessarily restricted to, one or more specific embodiments of the present invention. From this disclosure, those of skill in the art will recognize many variations and alternatives as to material, shape, size, design, configuration, combination, sub-combination, function, and manner of application and operation, which are nonetheless within the scope and spirit of the present invention. All such variations and alternatives should be understood as included invention and overall inventive concepts which are the subject of this invention, equally as if disclosed and described herein. Similarly, where any embodiment is described herein with specificity as to material, shape, size, design, configuration, combination, sub-combination, function, or manner of application and operation, such details and features are intended for illustration and example only, and not as limitations on the invention or the overall inventive concepts disclosed.

The invention claimed is:

1. A flying insect trap comprising: an enclosure having an upper end, a lower end, at least one side wall, and an aperture located in said side wall; an entry pipe inserted through the aperture of said enclosure, said entry pipe having an inner opening positioned inside said enclosure and an outer opening positioned outside said enclosure; and a top cap affixed to the top end of said enclosure, said top cap including a window which is transparent or translucent.

2. The flying insect trap of claim 1, wherein said entry pipe is curved or bent downward such that the distance from the inner opening of said entry pipe to the lower end of the enclosure is less than the distance from the aperture to the lower end of the enclosure.

3. The flying insect trap of claim 1, wherein the side wall of said enclosure is opaque, and said entry pipe is opaque.

4. The flying insect trap of claim 1, wherein the inner opening of said entry pipe has a smaller diameter than the outer opening of said entry pipe.

5. The flying insect trap of claim 1, wherein said enclosure includes threads located near the top end of said enclosure and said top cap includes threads matching the threads of said enclosure, such that said top cap is removably affixed to said enclosure.

6. The flying insect trap of claim 1, further comprising an entry cap affixed to and covering the outer opening of said entry pipe, said entry cap having a plurality of holes whose size is fixed to allow certain insects to enter said enclosure through said entry pipe while preventing other insects from entering said enclosure through said entry pipe.

7. The flying insect trap of claim 1, further comprising an insect attractant located within said enclosure.

8. The flying insect trap of claim 7, wherein said insect attractant is inactive until combined with water.

9. The flying insect trap of claim 7, wherein said insect attractant includes a surfactant component.

10. A flying insect trap comprising: an enclosure having an upper surface, a lower surface, at least one side wall, and an aperture located in said side wall; an entry pipe inserted through the aperture of said enclosure, said entry pipe having an inner opening positioned inside said enclosure and an outer opening positioned outside said enclosure; and a window located on the upper surface of said enclosure, said window being transparent or translucent.

11. The flying insect trap of claim 10, wherein said entry pipe is curved or bent downward such that the distance from the inner opening of said entry pipe to the lower end of the enclosure is less than the distance from the aperture to the lower end of the enclosure.

12. The flying insect trap of claim 10, wherein the side wall of said enclosure is opaque, and said entry pipe is opaque.

13. The flying insect trap of claim 10, wherein the inner opening of said entry pipe has a smaller diameter than the outer opening of said entry pipe.

14. The flying insect trap of claim 10, further comprising an entry cap affixed to and covering the outer opening of said entry pipe, said entry cap having a plurality of holes whose size is fixed to allow certain insects to enter said enclosure through said entry pipe while preventing other insects from entering said enclosure through said entry pipe.

15. The flying insect trap of claim 10, further comprising an insect attractant located within said enclosure.

16. The flying insect trap of claim 15, wherein said insect attractant is inactive until combined with water.

17. The flying insect trap of claim 15, wherein said insect attractant includes a surfactant component.
